(19) United States
(12) Patent Application Publication
(10) Pub. No.: US 2008/0266284 A1
(43) Pub. Date: Oct. 30, 2008

(54) Method for Driving LCD Panel

(76) Inventor: Wen-Shian Shie, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/782,645

(22) Filed: Jul. 25, 2007

(30) Foreign Application Priority Data
Apr. 26, 2007 (TW) 096114795

(51) Int. Cl. G06F 3/038

(52) U.S. Cl. 345/214

(57) ABSTRACT

A method for driving an LCD panel having a plurality of pixels corresponding to a matrix includes receiving an image data, setting polarities of the plurality of pixels according to an LCD panel driving procedure, dividing the plurality of pixels into a plurality of groups by lines of the matrix according to polarities of pixels corresponding to a column of the matrix, and sequentially scanning the pixels of the groups, so as to show the image data.

### BACKGROUND OF THE INVENTION

1. Field of the Invention

The present invention relates to a method for driving an LCD panel, and more particularly, to a method capable of decreasing polarity switching of pixels in a column of a frame.

2. Description of the Prior Art

The advantages of a liquid crystal display (LCD) include lighter weight, less electrical consumption, and less radiation contamination. Thus, the LCD monitors have been widely applied to various portable information products, such as notebooks, mobile phones, PDAs, etc. In an LCD monitor, incident light produces different polarization or refraction effects when the alignment of liquid crystal molecules is altered. The transmission of the incident light is affected by the liquid crystal molecules, and thus magnitude of the light emitting out of liquid crystal molecules varies. The LCD monitor utilizes the characteristics of the liquid crystal molecules to control the corresponding light transmittance and produces gorgeous images according to different magnitudes of red, blue, and green light.

Please refer to FIG. 1, which illustrates a schematic diagram of a prior art thin film transistor (TFT) LCD monitor 10. The LCD monitor 10 includes an LCD panel 100, a control circuit 102, a data-line-signal output circuit 104, a scan-line-signal output circuit 106, and a voltage generator 108. The LCD panel 100 is constructed by two parallel substrates, and the liquid crystal molecules are filled between these two substrates. A plurality of data lines 110, a plurality of scan lines 112 that are perpendicular to the data lines 110, and a plurality of TFTs 114 are positioned on one of the substrates. There is a common electrode installed on another substrate, and the voltage generator 108 is electrically connected to the common electrode for outputting a common voltage Vcom via the common electrode. Please note that only four TFTs 114 are shown in FIG. 1 for clarity. In reality, the LCD panel 100 has one TFT 114 installed in each intersection of the data lines 110 and scan lines 112. In other words, the TFTs 114 are arranged in a matrix format on the LCD panel 100. The data lines 110 correspond to different columns, and the scan lines 112 correspond to different rows. The LCD monitor 10 uses a specific column and a specific row to locate the associated TFT 114 that corresponds to a pixel. In addition, the two parallel substrates of the LCD panel 100 filled up with liquid crystal molecules can be considered as an equivalent capacitor 116.

The operation of the prior art LCD monitor 10 is described as follows. When the control circuit 102 receives a horizontal synchronization signal 118 and a vertical synchronization signal 120, the control circuit 102 generates corresponding control signals which are respectively inputted into the data-line-signal output circuit 104 and the scan-line-signal output circuit 106. The data-line-signal output circuit 104 and the scan-line-signal output circuit 106 then generate input signals to the LCD panel 100 for turning on the corresponding TFTs 114 and changing the alignment of liquid crystal molecules and light transmittance, so that a voltage difference can be kept by the equivalent capacitors 116, and image data 122 can be displayed in the LCD panel 100. For example, the scan-line-signal output circuit 106 outputs a pulse to the scan line 112 for turning on the TFTs 114. Therefore, the voltage of the input signal generated by the data-line-signal output circuit 104 is inputted into the equivalent capacitor 116 through the data line 110 and the TFTs 114. The voltage difference kept by the equivalent capacitor 116 can then adjust a corresponding gray level of the related pixel through affecting the related alignment of liquid crystal molecules positioned between the two parallel substrates. In addition, the data-line-signal output circuit 104 generates the input signals, and magnitude of each input signal inputted to the data line 110 is corresponding to different gray levels.

If the LCD monitor 10 continuously uses a positive voltage to drive the liquid crystal molecules, the liquid crystal molecules will not quickly change a corresponding alignment according to the applied voltages as before. Thus, the incident light will not produce accurate polarization or refraction, and the quality of images displayed on the LCD monitor 10 deteriorates. Similarly, if the LCD monitor 10 continuously uses a negative voltage to drive the liquid crystal molecules, the liquid crystal molecules will not quickly change a corresponding alignment according to the applied voltages as before. Thus, the incident light will not produce accurate polarization or refraction, and the quality of images displayed on the LCD monitor 10 deteriorates. In order to protect the liquid crystal molecules from being irregular, the LCD monitor 10 must alternately use positive and the negative voltages to drive the liquid crystal molecules. In addition, not only does the LCD panel 100 have the equivalent capacitors 116, but the related circuit will also have some parasite capacitors owing to its intrinsic structure. When the same image is displayed on the LCD panel 100 for a long time, the parasite capacitors will be charged to generate a residual image effect. The residual image with regard to the parasite capacitors will further distort the following images displayed on the same LCD panel 100. Therefore, the LCD monitor 10 must alternately use the positive and the negative voltage to drive the liquid crystal molecules for eliminating the undesired residual image effect. Please refer to FIG. 2 to FIG. 5. FIG. 2 and FIG. 3 are diagrams of a prior art line inversion driving procedure. FIG. 4 and FIG. 5 are diagrams of a prior art dot inversion driving procedure. In FIG. 2 and FIG. 3, blocks 200 and 300 show polarities of pixels in the same part of two successive image frames, and change to opposite polarities as a frame changes when the LCD panel is driven through line inversion. In FIG. 4 and FIG. 5, blocks 400 and 500 show polarities of pixels in the same part of two successive image frames, and polarities of adjacent pixels are different. The polarity of a pixel changes to an opposite polarity as a frame changes.

When driving an LCD panel through the line inversion driving method, polarities of pixels in two adjacent lines are different, and polarities of pixels in the same line change with frames, so that vertical flickers can be alleviated. When driving an LCD panel through the dot inversion driving method, polarities of two adjacent dots are different, and polarities of the same pixels change with frames, so as to alleviate both vertical and horizontal flickers. However, by these two driving methods, the number of polarity switching of pixels in the same column equals half of the number of rows, which causes energy waste.

Take FIG. 4 and FIG. 5 as an example, when displaying a frame, a prior art LCD device displays all pixels of a row L1 from left to right, then displays all pixels of a row L2 from left to right, and so on. At last, after displaying all pixels of a row L8, return to the row L1 to display the next frame. Related driving signals are shown in FIG. 6, and high-level square waves are used for turning on corresponding pixels in the rows to display image. Under this condition, observing pixels in the same column (such as a column CH1), we can know that after scanning a frame, the pixels in the same column switch polarities for half of the number of rows (4 times in this example). Pixel polarities are switched through switching a level of a common electrode voltage generator (like the voltage generator in FIG. 1) and switching scan line levels (outputted from the scan line signal output circuit 106). Consequently, huge power consumptions of a prior art line inversion driving method or a dot inversion driving procedure limit developments of the LCD panel. While sizes of LCD panels are growing, so does the number of polarity switching of the pixels in the same column grow. For example, if an LCD panel bears 256 rows, pixel polarities in the same column switch 128 times. Thus, power consumption is increased, and utility range is limited.

### SUMMARY OF THE INVENTION

It is therefore a primary objective of the claimed invention to provide a method for driving a LCD panel.

The present invention discloses a method for driving a liquid crystal display (LCD) panel having a plurality of pixels corresponding to a matrix, the method comprising receiving image data, setting polarities of the plurality of pixels according to an LCD panel driving procedure, dividing the plurality of pixels into a plurality of groups by rows of the matrix according to polarities of pixels corresponding to a column of the matrix, and scanning the pixels of the groups sequentially for displaying the image data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a prior art thin film transistor liquid crystal display monitor.

FIG. 2 and FIG. 3 illustrate schematic diagrams of a prior art line inversion driving method.

FIG. 4 and FIG. 5 illustrate schematic diagrams of a prior art dot inversion driving procedure.

FIG. 6 illustrates a schematic diagram of driving signals corresponding to FIG. 4 and FIG. 5.

FIG. 7 illustrates a diagram of driving a liquid crystal display panel according to an embodiment of the present invention.

FIG. 8 illustrates a schematic diagram of driving signals that drive a block in FIG. 4 according to an embodiment of the present invention.

FIG. 9 and FIG. 10 illustrate schematic diagrams of a two-line dot inversion driving procedure.

FIG. 11 illustrate schematic diagrams of driving signals that drive a block in FIG. 9 according to an embodiment of the present invention.

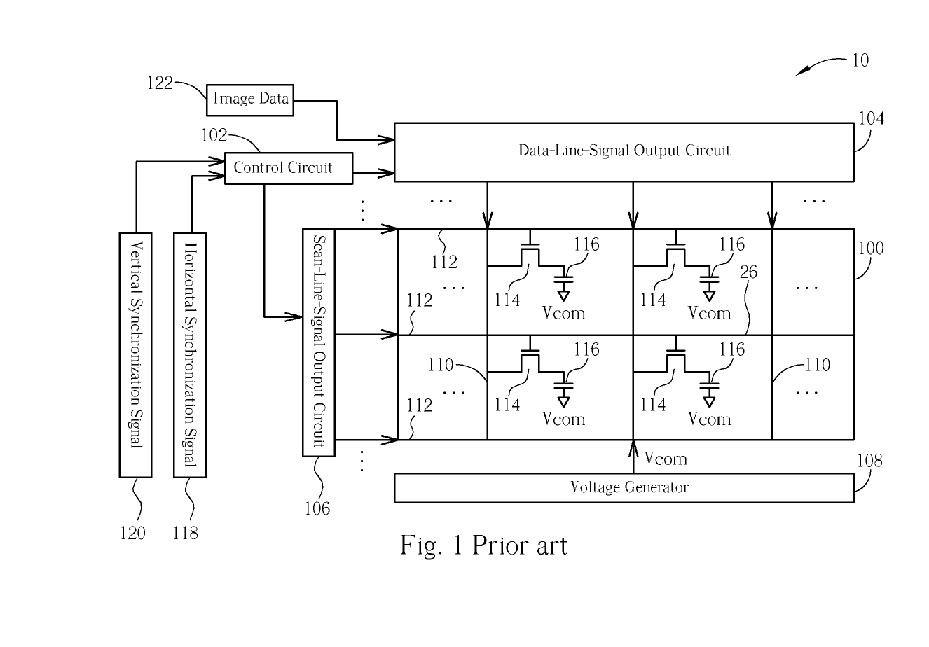

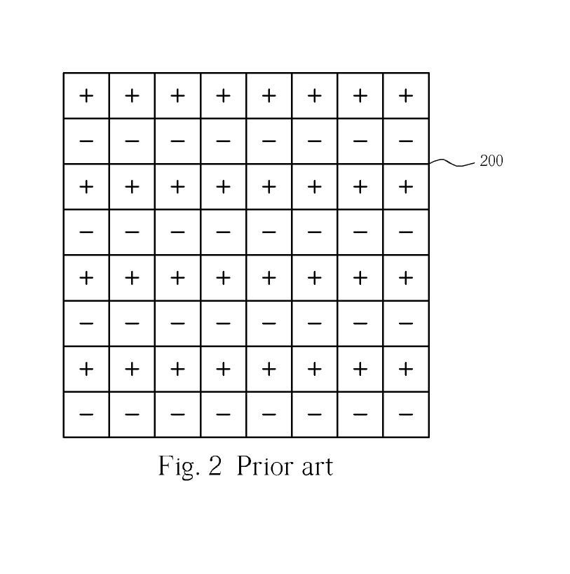

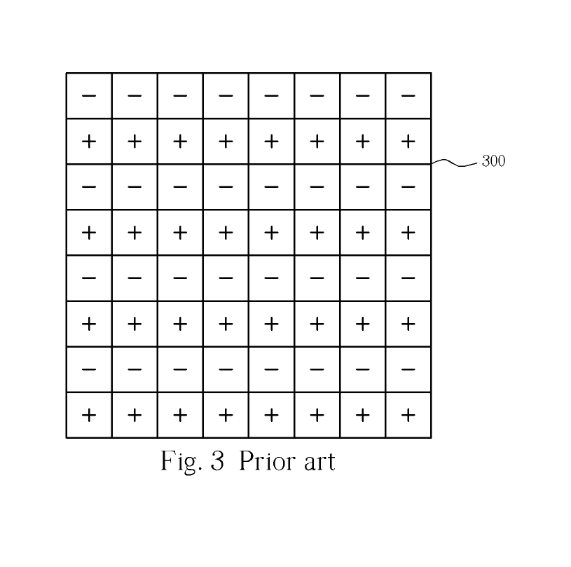

### DETAILED DESCRIPTION

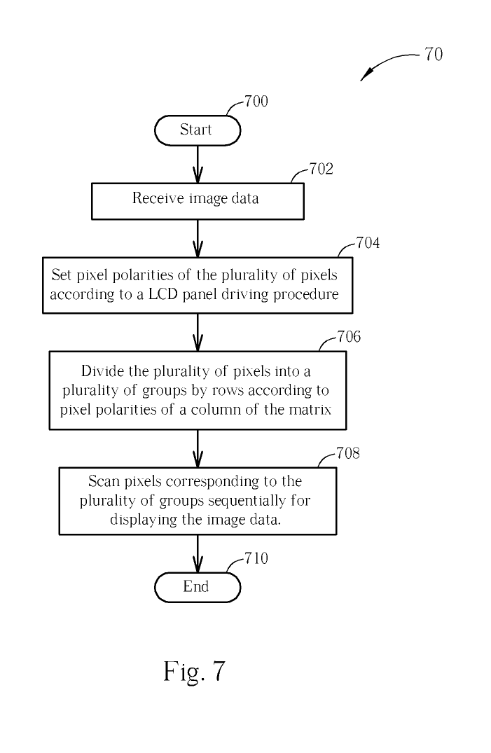

Please refer to FIG. 7, which illustrates a schematic diagram of a process 70 for driving an LCD panel according to an embodiment of the present invention. The LCD panel includes a plurality of pixels corresponding to a matrix. The process 70 includes the following steps:

Step 700: Start.

Step 702: Receive image data.

Step 704: Set pixel polarities of the plurality of pixels according to a LCD panel driving procedure.

Step 706: Divide the plurality of pixels into a plurality of groups by rows according to pixel polarities of a column of the matrix.

Step 708: Scan pixels corresponding to the plurality of groups sequentially for displaying the image data.

Step 710: End.

According to the process 70, the present invention sets pixel polarities of the LCD panel with a specific LCD panel driving procedure (such as a dot inversion driving procedure, a line inversion driving procedure, etc), and divides pixels of the LCD panel into a plurality of groups by rows according to polarities of pixels in a column, so as to sequentially scan the pixels of each group and display the image data. Preferably, the present invention sets pixels of rows corresponding to pixels having same polarities in the column as the same group. Hence, through the process 70 of the present invention, the number of polarity switching of the pixels in the same column in a frame can be decreased dramatically, or even switching once only. Consequently, power consumption of the LCD panel decreases dramatically.

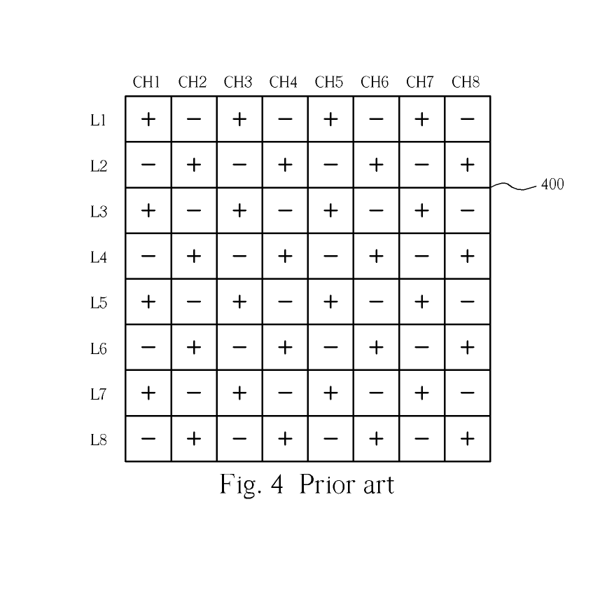

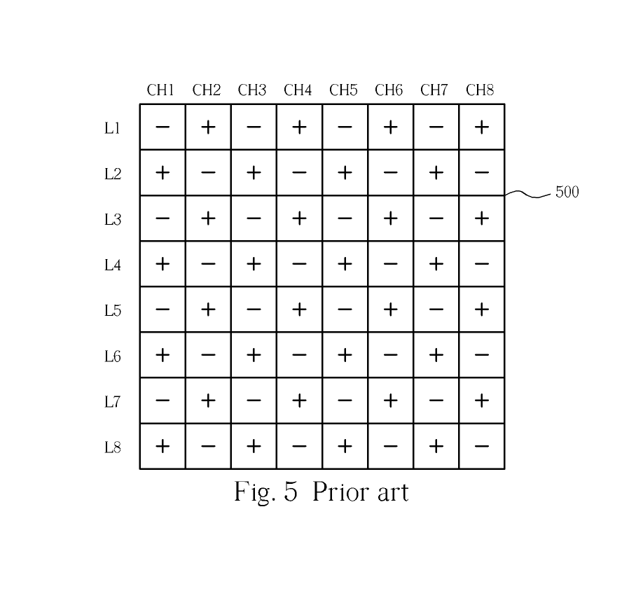

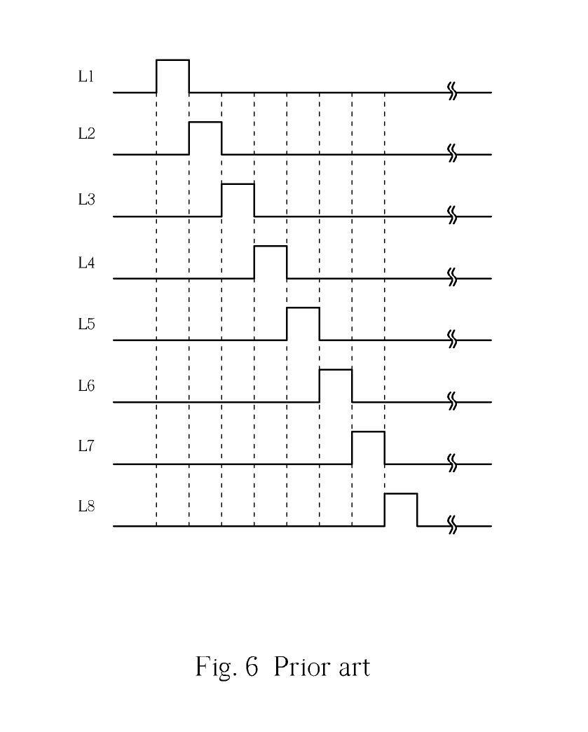

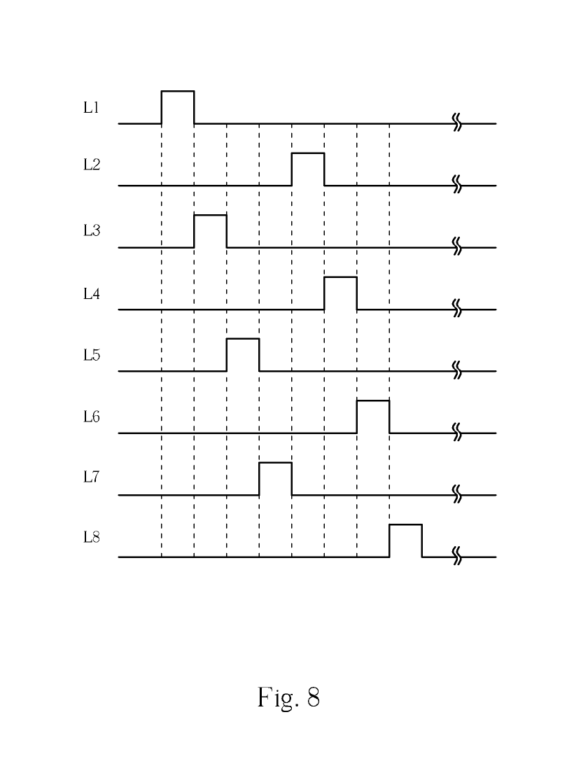

Take FIG. 4 as an example, the pixel polarities of the column CH1 in the block 400 are switched alternately. Hence, according to the process 70, rows L1, L3, L5, L7 can be set as a first group, rows L2, L4, L6, L8 can be set as a second group, and pixels thereof are sequentially scanned accordingly. Related driving signals are shown in FIG. 8, where high-level square waves are used for turning on corresponding pixels in the rows to display image. FIG. 8 shows that the rows (L1, L3, L5, L7) corresponding to positive polarity pixels in the column CH1 of the block 400 is sequentially scanned first, and then the rows (L2, L4, L6, L8) corresponding to negative polarity pixels in the column CH1 take turns. In this way, the number of polarity switching of the pixels in the same column in the frame is reduced to one, which is obviously superior to the prior art, and power consumption is decreased.

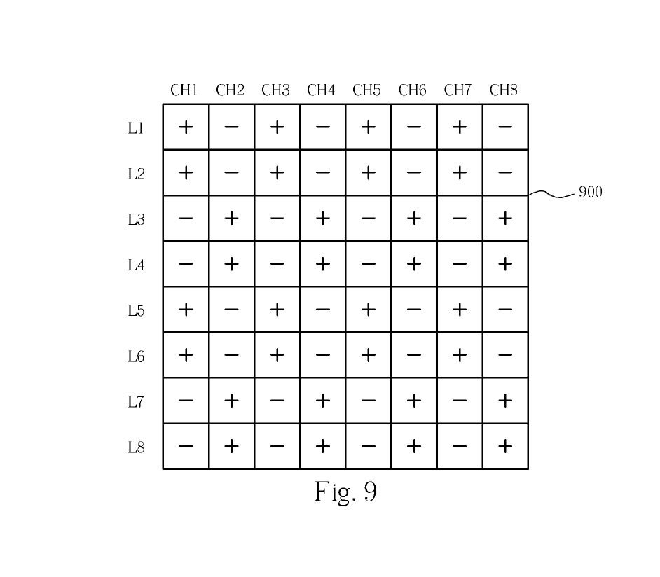

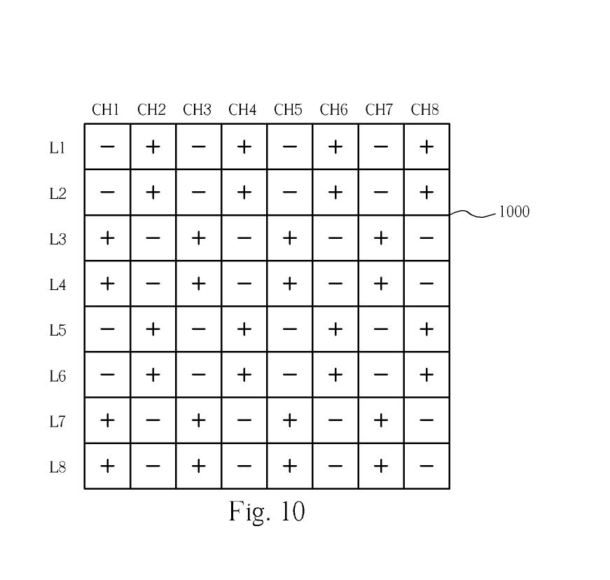

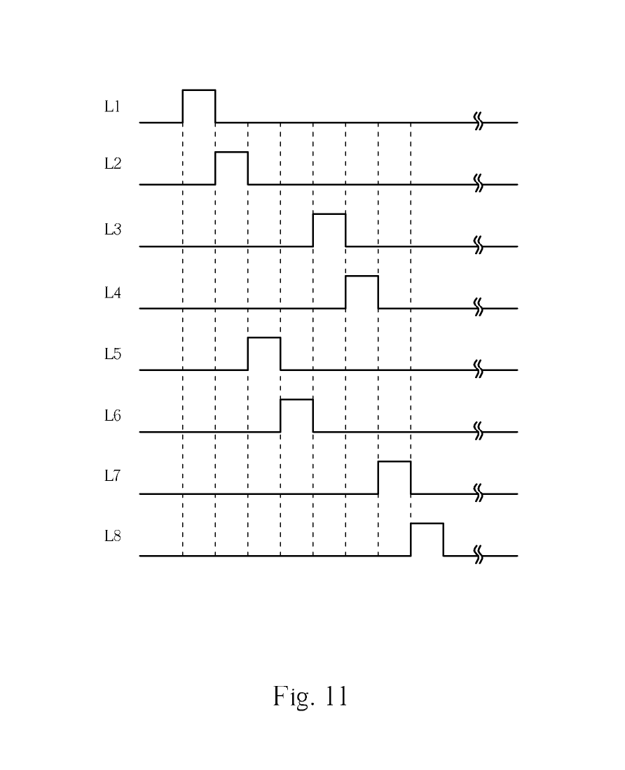

That is to say, through the process 70, the number of polarity switching of the pixels in the same column in the same frame is reduced, so as to decrease power consumption especially for larger size LCD panels, and to increase the utility range. Note that, the above-mentioned embodiments are merely used to explain operations of the present invention, but not to limit the present invention. Those skilled in the art can make modifications. For example, pixels of rows corresponding to pixels having same polarities in the column can be divided into a plurality of sub-groups, and the pixels in each sub-group are sequentially scanned. Further more, the LCD panel driving procedure of the present invention is not limited to any specific driving procedure. For example, FIG. 9 and FIG. 10 illustrate schematic diagrams of a two-line dot inversion driving procedure. Block 900 and block 1000 show polarities of pixels in the same part of two successive image frames. According to the process 70, when driving the block 900, rows L1, L2, L5, L6 are set as a group, and rows L3, L4, L7, L8 are set as another group, then the rows L1, L2, L5, L6, L3, L4, L7, L8 are sequentially scanned. Related driving signals are shown in FIG. 11.

As a conclusion, the present invention sets pixels of rows corresponding to pixels having same polarities in the column as a same group by lines, and sequentially scan pixels of each group to display image data. As a result, the present invention dramatically decreases the number of polarity switching of the pixels in the same column, or to only one, so as to decrease power consumption.

Those skilled in the art will readily observe that numerous modifications and alterations of the device and method may be made while retaining the teachings of the invention.

What is claimed is:

1. A method for driving a liquid crystal display (LCD) panel having a plurality of pixels corresponding to a matrix, the method comprising:
receiving image data;
setting polarities of the plurality of pixels according to an LCD panel driving procedure;
dividing the plurality of pixels into a plurality of groups by rows of the matrix according to polarities of pixels corresponding to a column of the matrix; and
scanning the pixels of the groups sequentially for displaying the image data.

2. The method of claim 1, wherein the LCD panel driving procedure is a dot inversion driving procedure.

3. The method of claim 1, wherein the LCD panel driving procedure is a line inversion driving procedure.

4. The method of claim 1, wherein the LCD panel driving procedure is a two-line dot inversion driving procedure.

5. The method of claim 1, wherein dividing the plurality of pixels into the plurality of groups by rows of the matrix according to the polarities of the pixels corresponding to the column of the matrix is setting pixels of rows corresponding to pixels with a first polarity in the column as a first group, and setting pixels of rows corresponding to pixels with a second polarity in the column as a second group according to the polarities of the pixels corresponding to the column of the matrix.

6. The method of claim 5 further comprising dividing pixels corresponding to the first group into a plurality of first sub-groups, and dividing pixels corresponding to the second group into a plurality of second sub-groups.

7. The method of claim 5, wherein scanning the pixels of the groups sequentially for displaying the image data is scanning pixels corresponding to the plurality of first sub-groups and the plurality of second sub-groups sequentially for displaying the image data.
